(19) United States
(12) Patent Application Publication
(10) Pub. No.: US 2026/0246909 A1
(43) Pub. Date: Aug. 20, 2026

(54) OPPORTUNISTIC PROJECTION ONTO DYNAMIC LIGHT REFLECTIVE MATERIAL

(71) Applicant: DISNEY ENTERPRISES, INC., Burbank, CA (US)

(72) Inventors: Lanny S. Smoot, Thousand Oaks, CA (US); Jack Wetherell, Burbank, CA (US); Samantha Cheuklum Ho, Los Angeles, CA (US); Richard Erik Sotomayor, Los Angeles, CA (US)

(21) Appl. No.: 19/058,422

(22) Filed: Feb. 20, 2025

(51) Int. Cl. H04N 13/32; G02F 1/167; H04N 13/122; H04N 13/139; H04N 13/351; H04N 13/398

(52) U.S. Cl. CPC H04N 13/32; G02F 1/167; H04N 13/122; H04N 13/139; H04N 13/351; H04N 13/398

(57) ABSTRACT

A system may include a camera configured to capture an image of a light reflective material in an area, and a controller configured to detect, based on the captured image, a dynamic characteristic of the light reflective material, and determine, based on the detected dynamic characteristic, content to be projected onto the light reflective material. The system may include a light source configured to emit nonvisible light in the area and a projector configured to project content onto a dynamic light reflective material in the area. The system may include a sensor configured to detect a characteristic of the light reflective material based on a reflection of the nonvisible light off the dynamic light reflective material. The controller may be configured to modify the content based on a change to the detected characteristic of the light reflective material.

### FIELD

The present application relates to projection systems, such as projecting animations, imagery, and other content onto changing materials or surfaces.

### BACKGROUND

Animations and imagery are often projected onto known surfaces, such as buildings, screens, and walls. These surfaces are often fixed with known characteristics (e.g., shape, size, orientation, reflectivity, etc.). Using the known characteristics, projections can be created to fit the known surfaces.

However, it may be desirable to project images on other surfaces where the size, shape, density and reflectivity of the surface may be changing dynamically, so as to provide a more immersive or tailored experience to guests or onlookers.

### BRIEF SUMMARY

In one example, a system includes a camera configured to capture an image of a light reflective material in an area, and a controller configured to detect, based on the captured image, a dynamic characteristic of the light reflective material, and determine, based on the detected dynamic characteristic, content to be projected onto the light reflective material.

Optionally, the controller is further configured to adjust the content to conform the content to the dynamic characteristic.

Optionally, the dynamic characteristic includes a continuously varying characteristic of the light reflective material.

Optionally, the dynamic characteristic includes a changing size and shape of a projectable area defined by the light reflective material.

Optionally, the light reflective material is defined by particles suspended or floating in air. The particles may include at least one of firework residue, fog, smoke, mist, or clouds.

Optionally, the light reflective material is defined by particles suspended or floating on or in water or other transparent liquid.

Optionally, the light reflective material includes an undulating flexible material.

Optionally, the system includes a light source configured to emit light in the area, wherein the controller is configured to detect the dynamic characteristic based on a reflection of the light off the light reflective material. The light may be nonvisible light. The light source may be configured to emit a short pulse of visible projection light used to determine the dynamic characteristic of the light reflective material.

Optionally, the controller is configured to detect a variation in uniformity of the light reflective material, and to determine, based on the detected variation in uniformity, a correction matte required to provide a uniform image brightness across the light reflective material.

Optionally, the system includes a distance sensor configured to determine a distance from the camera or a projector to the light reflective material. The light reflective material may define multiple separate projectable areas at varied distances from the camera or the projector, wherein the multiple separate projectable areas are used to provide a construction of visible multiplane or sloped three-dimensional images.

Optionally, the system includes a projector configured to project the content onto the light reflective material.

Optionally, the controller is configured to detect, based on the captured image, an updated characteristic of the light reflective material, and adjust, based on the updated characteristic, the content such that the content corresponds to the light reflective material. The updated characteristic may include an updated projectable area defined by the light reflective material, wherein the controller is configured to adjust the content to fit the content within the updated projectable area. The updated characteristic may include an updated density of the light reflective material.

Optionally, the light reflective material defines a projectable area, and the controller is configured to determine a periphery of the projectable area and adjust the content to include a border along the periphery. The controller may be configured to further adjust the content based on a change to the border along the periphery.

In another example, a system includes a light source configured to emit nonvisible light in an area, a projector configured to project content onto a dynamic light reflective material in the area, a sensor configured to detect a characteristic of the dynamic light reflective material based on a reflection of the nonvisible light off the dynamic light reflective material, and a controller configured to modify the content based on a change to the detected characteristic of the dynamic light reflective material.

Optionally, the dynamic light reflective material defines a diffuse projection cloud of particles suspended in air. The system may include a diffuser configured to diffuse the particles in the air. The controller may be configured to modify a position or a shape of the content as the diffuse projection cloud dissipates. The controller may be configured to determine a usable projectable area defined by the dynamic light reflective material as the diffuse projection cloud dissipates and define a border for projection along a periphery of the usable projectable area. The controller may be configured to modify the content to interact with the border.

Optionally, the change includes an updated size and shape of a projectable area defined by the dynamic light reflective material, wherein the controller is configured to modify the content to fit the content to the updated size and shape.

Optionally, the sensor is configured to track a position of the dynamic light reflective material.

Optionally, the dynamic light reflective material is defined by a floating or suspended structure.

Optionally, the controller is configured to utilize generative artificial intelligence (AI) to create or modify the content.

In another example, a method includes detecting, by a processor and based on an image of a light reflective material, a dynamic characteristic of the light reflective material, and determining, by the processor and based on the detected dynamic characteristic, content to be projected onto the light reflective material.

Optionally, the method includes detecting, by the processor and based on a subsequent image of the light reflective material, a change to the detected dynamic characteristic, and adjusting, by the processor, the content based on the detected change.

In addition to the exemplary aspects and embodiments described above, further aspects and embodiments will become apparent by reference to the drawings and by study of the following description.

### BRIEF DESCRIPTION OF THE DRAWINGS

FIG. 1 is a schematic illustration of a system.

FIG. 2 illustrates an example generation of light reflective material onto which content may be projected.

FIG. 3A illustrates an example light reflective material onto which content may be projected.

FIG. 3B illustrates example projection of content onto the light reflective material of FIG. 3A.

FIG. 4 illustrates another example generation of light reflective material, as well as a projection of dynamic content in an example first configuration based on the light reflective material.

FIG. 5 illustrates a projection of the dynamic content in an example second configuration based on a change to the light reflective material.

FIG. 6 illustrates a projection of the dynamic content in an example third configuration based on a further change to the light reflective material.

FIG. 7 illustrates a projection of the dynamic content in an example fourth configuration based on a further change to the light reflective material.

FIG. 8 illustrates a projection of the dynamic content in an example fifth configuration based on a further change to the light reflective material.

FIG. 9 illustrates a projection of the dynamic content in an example sixth configuration based on a further change to the light reflective material.

FIG. 10 illustrates another example projection of content onto a light reflective material.

FIG. 11 illustrates another example projection of content onto a light reflective material.

FIG. 12 illustrates an example generation of content.

FIG. 13 illustrates an example computing system for implementing various examples of the present disclosure.

FIG. 14 illustrates a flow chart providing an example method of projecting content onto light reflective material.

### DETAILED DESCRIPTION

Opportunistic projection of animations, imagery, or other content onto dynamic light reflective material is disclosed. In one example, systems and methods may detect an available projectable area or surface. For example, at least a portion of an area (e.g., the sky) may be illuminated with light. The light may be invisible, for example, infrared light. The illuminated area may be detected, e.g., with a camera or sensor. For example, an infrared camera may capture an infrared image of the illuminated area. The area may include or be filled with a diffuse material (e.g., fog, smoke, fireworks residue, light reflective material, etc.). The diffuse material may appear within the captured image as the diffuse material reflects light to the camera. Where there is little to no diffuse material, light is not returned or reflected to the camera. In this manner, the diffuse or reflectable area may be detected by the system and defined as a projectable area. In this manner, projected content may be configured to correspond to the detected projectable area, e.g., reshaped, sized, and/or brightness or color modified based on characteristics of the projectable area.

In another example, the projected content may be adjusted or modified to fit complex shape changes of the projectable area or light reflective material. For example, the projected content may change as the diffuse material dissipates or flows, such as the system automatically determining the changing shape of the diffuse material and reforming the character or projected content to fit the changing shape. In this manner, the projected content may be chosen, created, or modified based on the available shape and size of a particular projection cloud of diffuse material. The content choice, creation, and modification may follow an opportunistic projection algorithm. For example, the system may determine the exact shape of a projectable area, whether defined by diffuse material, fabric, screens, or otherwise, and use the determined shape to tailor the projected imagery.

In many embodiments, the system can dynamically adjust the content to correspond to an unknown and often quickly changing projectable area. Additionally, because the projectable area may be in parts of the environment, such as the sky, the effect may be immersive, realistic, and create a magic experience for guests. As a specific example, smoke, such as after fireworks, may be used create a secondary show that follows a fireworks display, by projecting content onto the smoke clouds.

In some instances, images may be tailored to the dynamic light reflective material. For example, computer-generated images (e.g., generated images such as those created via a generative model) may be tailored to a constantly changing (e.g., in size and shape) projectable area. For example, a detected projectable area may be taller than it is wide. In such examples, the system may choose to project a standing character with a humanoid shape in the projectable area. If, on the other hand, the projectable area is wider than it is tall, the system may choose to project the character as laying down on a bed. Where the shape of the projectable area is changing, for instance, the projectable area is becoming smaller, the projected character may shrink (e.g., automatically) correspondingly, and vice-versa. Along with geometric changes, the computer-generated images may be part of a theme, but change as the available projectable area morphs. The images may be created using generative artificial intelligence (AI).

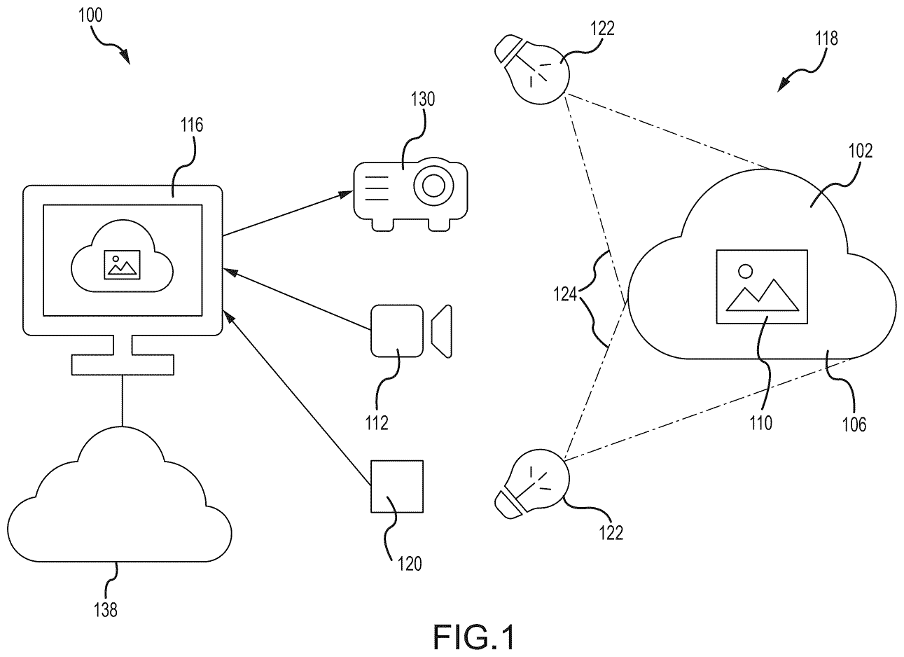

FIG. 1 is a schematic illustration of a system 100. The system 100 may be configured to track and project opportunistic animations or imagery (or any content) on light reflective material 102, such as fog, smoke, bubbles, balloons, airborne debris, and/or screens, among other elements, as described below. For example, the system 100 may detect an available projectable surface or element or a combination of surfaces or elements (e.g., a projectable area 106 defined by the light reflective material 102) and opportunistically project content 110 onto the detected area. The opportunistic or dynamic projection may be chosen or generated based on an available shape and/or size of the projectable area 106. In another example, the system 100 may adjust or modify the content 110 based on changing conditions of the projectable area 106. For example, the system 100 may modify the content 110 based on detected characteristics of the projectable area 106 (e.g., automatically, in real time or near real time, based on a detected change), as detailed below.

The system 100 may include a detector system (e.g., a camera 112) and a controller 116. The camera 112 may be configured to detect characteristics of the light reflective material 102 in an area 118. For example, the camera 112 may be configured to capture an image or other information of the light reflective material 102. The camera 112 may be a visible light camera or a nonvisible light camera. For example, the camera 112 may include an infrared (IR) camera. In another example, other sensors or modalities may be utilized to detect characteristics of the light reflective material 102. For example, the system 100 may include a distance sensor 120 configured to determine a distance from at least one of the camera 112 or projector 130 to the light reflective material 102 or projectable area 106, for example, to portions of the projectable area 106 or to multiple separate projectable surfaces or areas. The distance sensor 120 may include light detection and ranging (LiDAR), radar, or other sensors. In this manner, the system 100 may broadly include a sensor or other detector system configured to detect a characteristic of the light reflective material 102.

The light reflective material 102 may by formed by one or multiple elements onto which light may be projected, such as to create a visual image for viewing (e.g., the content 110). For example, the light reflective material 102 may be defined by a static structure, such as a screen, wall, building, or other static surface. In another example, the light reflective material 102 may be defined by a moving surface, such as a flag, windsock, banner, suspended fabric, one or more aerial vehicles, a moving ground vehicle, falling water, water surfaces, etc. In another example, the light reflective material 102 may include an undulating flexible material (e.g., a flag or banner waiving in the wind, etc.). In another example, the light reflective material 102 may be defined by particles suspended or floating in air or a liquid. For example, the light reflective material 102 may be defined by smoke, fog, mist, low-lying clouds, firework residue, etc., as detailed more fully below. In another example, the light reflective material 102 may be surrounded by non-light reflective areas. For example, the light reflective material 102 may be defined by one or more surfaces or particles surrounded by air. In another example, the light reflective material 102 may be defined by nontransparent material in clear liquid.

In some examples, the system 100 includes one or more light sources 122 (hereinafter “light source 122”). The light source 122 may be configured to emit light 124 in the area 118. The light 124 may be visible or nonvisible light. For example, the light 124 may be IR light. In such examples, the light source 122 may be an IR light source or illuminator to light up the area 118 with IR light. The light source 122 may be a broad source of IR, such as an IR cannon. In such examples, the light source 122 may emit IR light in the area 118, and the camera 112 may capture an IR image of the light reflective material 102. In other examples, the light source 122 may generate ultraviolet light or another spectrum of light. Nonvisible light may be preferential to limit or prevent people from seeing the light, although nonvisible light is not required. For example, the light source 122 may emit visible light. For example, the light source 122 may emit a short pulse of visible projection light used to determine a dynamic characteristic of the light reflective material 102. In some examples, tilt mirrors may be used to direct the light source 122 or light 124 towards the area 118.

The camera 112 may detect light reflected off the light reflective material 102. For example, the camera 112 may detect reflected visible or nonvisible light. The reflected light may be different than the light 124 emitted from the light source 122, such as due to absorption, scatter, transmission, etc. By detecting the reflected light, the camera 112 may be configured to detect (e.g., “see”) the light reflective material 102. For example, the reflected light detected by the camera 112 may indicate a size, shape, or other characteristic of the light reflective material 102. In some examples, the camera 112 may detect the characteristics automatically, such as using machine vision or other algorithms (e.g., using machine learning, classifiers, image detection, machine assisted determination, etc.). As a result, the camera 112 or other sensor may be configured to detect one or more characteristics of the light reflective material 102 based on a reflection of light 124 off the light reflective material 102. In one example, the camera 112 may be optically aligned with the light source 122. For example, tilt mirrors may be used to direct the camera 112 towards the illuminated area 118.

The detected characteristics may indicate a “projectability” of the light reflective material 102. In one example, a minimum threshold characteristic may be needed for the content 110 to be visualized (e.g., visible images, video, imagery, etc.) on the light reflective material 102. For example, the threshold characteristic may determine whether someone can see what is projected. The threshold characteristic may include a density of the light reflective material 102, such as in the case of suspended or floating nontransparent particles. The density may include an optical density or the quantity of suspended or floating nontransparent particles per unit volume. Optical density may be defined as the quantity of light absorbed by the light reflective material 102 as light passes through the material. In these and other examples, a minimum density of the nontransparent particles in the area 118 may be needed for sufficient projection of content 110 onto the particles. The detected characteristics may indicate other features of the light reflective material 102, such as a size or shape of the light reflective material 102. Based on the detected characteristics, the system 100 may determine the content 110 to be projected onto the light reflective material 102, as detailed below.

For example, the system 100 may include a projector 130. The projector 130 may be configured to project content 110 onto the detected light reflective material 102. For example, the projector 130 may be an optical device configured to project an image or moving images (e.g., content 110) onto the light reflective material 102. The projector 130 may project the content 110 directly or indirectly through one or more lenses. The projector 130 may include a video projector, laser scanner, or selectable masks over a continuous light source).

The controller 116 may include one or more processors configured to receive and process data or information. For example, the controller 116 may use information or data captured by the camera 112 (e.g., an image) to determine or detect one or more characteristics of the light reflective material 102. In some examples, the controller 116 may query a database (e.g., a local database, an online database, a server, etc.), such as to identify the light reflective material 102, access information about the light reflective material 102, or the like. Such information may include physical properties of the light reflective material 102.

Based on the image or other data captured by the camera 112, the controller 116 may be configured to detect a dynamic characteristic of the light reflective material 102. In one example, the dynamic characteristic may include a continuously varying characteristic of the light reflective material 102. In another example, the detected characteristic may be an updated characteristic of the changing light reflective material 102 (e.g., based on a subsequent image of the light reflective material 102). For example, the dynamic characteristic may include a changing size and shape of the light reflective material 102 itself or the projectable area 106 defined by the light reflective material 102 (e.g., the projectable area 106 satisfying a minimum threshold projectability characteristic). In another example, the updated characteristic may include an updated density of the changing light reflective material 102 (e.g., as the light reflective material 102 dissipates from the area 118), as detailed below.

Based on the detected dynamic characteristic, the controller 116 may be configured to determine the content 110 to be projected onto the light reflective material 102. In one example, the controller 116 may be configured select, adjust, or modify the content 110, such that the content 110 corresponds to the changing light reflective material 102, as detailed below. For example, the controller 116 may be configured to adjust the content 110 to conform the content 110 to the dynamic characteristics of the light reflective material 102. One example includes conforming the content 110 to match the changing size and shape of the light reflective material 102 or projectable area 106. In another example, the controller 116 may be configured to modify the content 110 based on a change to the detected characteristic of the light reflective material 102. For example, the controller 116 may modify the imagery to fit the content 110 to or within the projectable area 106, as detailed below. The controller 116 may also create a returned invisible light brightness matte, and adjust the brightness of the visible light used for projection to make the visible image uniform across variations in density or local reflectivity of the dynamic media. For example, the controller 116 may determine the amount of reflected light and modify the brightness of the projection accordingly so that the visible content 110 appears uniform or generally uniform. In one example, the controller 116 may be configured to detect a variation in uniformity of the light reflective material 102, for example, in density or local reflectivity. Based on the detected variation in uniformity, the controller 116 may determine a correction matte required to provide a uniform image brightness across the light reflective material 102. In this manner, the controller 116 may account for areas of the light reflective material 102 with less density or local reflectivity that would otherwise result in incorrect or inconsistent visibility of the content 110.

In some examples, the system 100 may include a network 138. The network 138 may facilitate communications between various components of the system 100. For example, the network 138 may include hardware, software, or both providing one or more interfaces for communication between the camera 112, controller 116, light source 122, projector 130, or other components of the system 100 (e.g., one or more computer systems, sensors, or devices). The network 138 may include a modem, Ethernet card, a network interface controller (NIC) or network adapter for communicating with an Ethernet or other wire-based network, a wireless NIC (WNIC) or wireless adapter for communicating with a wireless network, such as a WI-FI network.

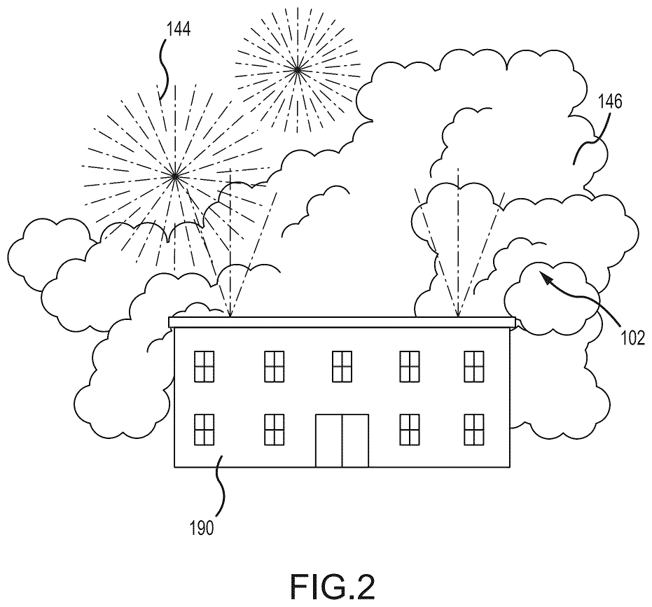

FIG. 2 illustrates an example generation of the light reflective material 102 onto which the content 110 may be projected. Referring to FIG. 2, one or more air-launched fireworks 144 may leave explosive residue 146. The residue 146 may be formed by debris and other particles generated or released by the explosion of the air-launched fireworks 144. The residue 146 may be dense and linger in the air for a period. For example, the residue 146 may define a residue cloud that dissipates or moves (e.g., due to existing wind and other conditions). The residue 146 may be nontransparent to define the light reflective material 102. In other words, the residue 146 may be “projection-able,” meaning the content 110 may be projected onto the nontransparent residue 146 for visualization.

In such examples, the light source 122 may illuminate the residue 146 with the light 124 (e.g., IR or nonvisible light). The camera 112 may detect the residue 146 through reflected light, such as detecting a size, shape, density, or movement of the residue 146. One or more images (e.g., the content 110) may be advantageously projected onto the residue 146. The content 110 may conform or correspond to a continuously varying residue cloud shape. For example, through continuous or near continuous IR illumination of the residue 146, the controller 116 may detect the size, shape, density and position of the residue cloud and adjust the projection of images to conform, correspond, or fit the content 110 to the changing residue cloud shape.

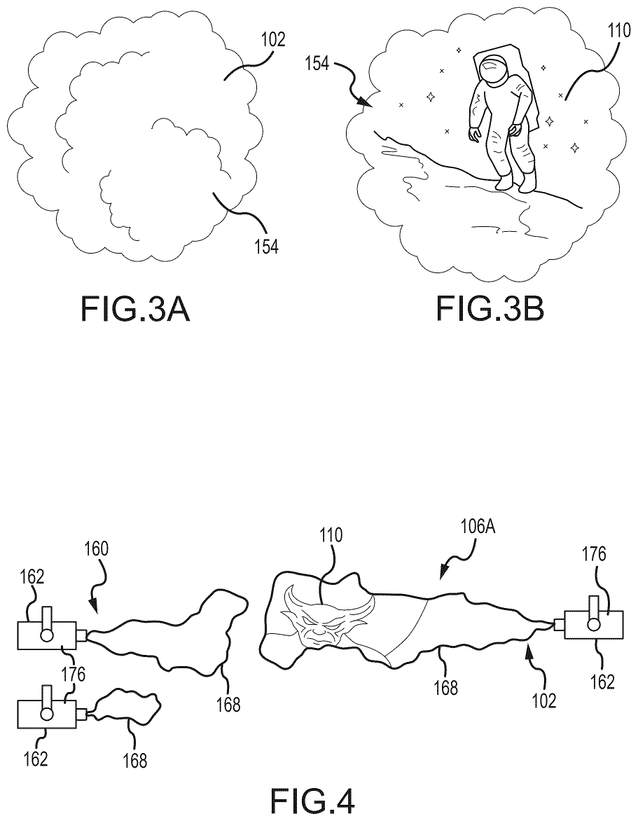

FIG. 3A illustrates another example of the light reflective material 102 onto which the content 110 may be projected. In one example, the light reflective material 102 may be defined by a cloud of smoke 154. The cloud of smoke 154 may be generated by a smoke machine or released from a popped smoke-filled balloon or bubble. The cloud of smoke 154 may be defined by suspended particles of nontransparent material. The camera 112 may detect the cloud of smoke 154 in a manner similar to detection of the residue 146, described above. For example, the camera 112 may detect the cloud of smoke 154 through reflected light, such as detecting a size, shape, density or movement of the cloud of smoke 154.

FIG. 3B illustrates an example projection of the content 110 onto the cloud of smoke 154. One or more images (e.g., content 110) may be advantageously projected onto the cloud of smoke 154. The content 110 may generally correspond to the size and shape of the cloud of smoke 154. For example, the content 110 may be chosen to fit within the projectable area 106 of the cloud of smoke 154. Referring to FIG. 3A, the cloud of smoke 154 (or light reflective material 102 in general) may include undulations, depressions, and other features defining a nonplanar projectable area 106. Referring to FIG. 3B, the projection may account for the nonplanar characteristics. For example, projection characteristics may be modified to provide a desired two-dimensional (2D) or three-dimensional (3D) characteristic of the visualized content 110, such as to smooth out the nonplanar characteristics of the cloud of smoke 154. For example, LiDAR or other depth detecting modalities or sensors may be used to determine a dimensionality, angle, position, distance, or other 2D or 3D characteristic of the projectable area 106 or light reflective material 102.

FIG. 4 illustrates another example generation of the light reflective material 102. In one example, the light reflective material 102 may be defined by fog 160. The fog 160 may be generated by one or more fog machines 162. The content 110 may be projected onto the fog 160 in a manner similar to the cloud of smoke 154 and/or the residue 146, described above. For example, the camera 112 may detect the fog 160 through reflected light, such as detecting a size, shape, reflectivity, or movement of the fog 160. One or more images (e.g., the content 110) may be advantageously projected onto the fog 160, such as the content 110 generally conforming or corresponding to a changing shape of the fog 160.

FIG. 4 illustrates a projection of content 110 in an example first configuration based on the light reflective material 102. In the first configuration, the light reflective material 102 may define a first projectable area 106A. For example, in the first configuration, the light reflective material 102 may have a first shape defining the first projectable area 106A. As shown in FIG. 4, the first projectable area 106A may be distributed amongst multiple (e.g., two, three, or more than three) subareas spaced from one another. For example, the light reflective material 102 may define multiple separate projectable areas or surfaces. The multiple areas or surfaces may be used to provide the construction of the content 110, such as visible multiplane or sloped 3D images.

The controller 116 may be configured to determine a periphery of the first projectable area 106A. In another example, the controller 116 may be configured to adjust the content 110 to include a border 168 along the periphery. For example, each subarea may include a border 168 to define the limits of feasible projection or projectability onto the projectable area 106 (e.g., the usable space of the projectable area 106). The content 110 may correspond to the first projectable area 106A. For example, the controller 116 may fit the content 110 to the first projectable area 106A, such as to fit within the border(s) 168.

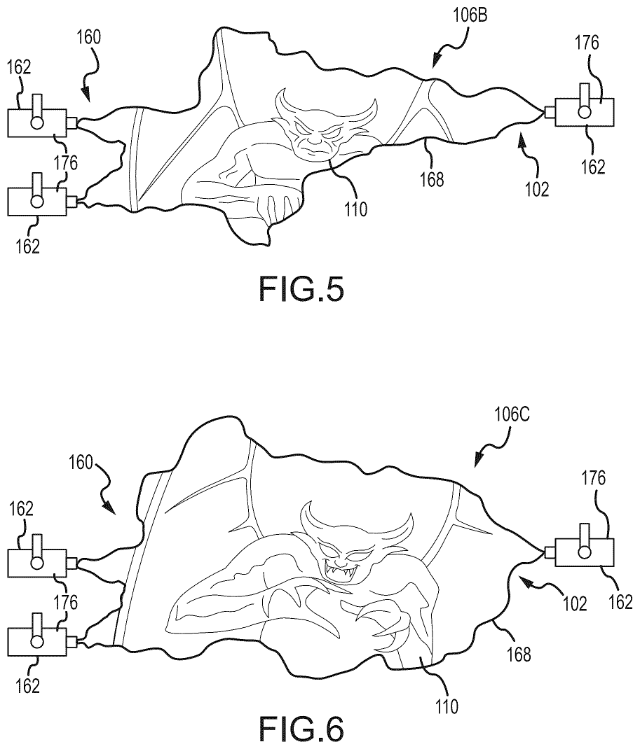

FIG. 5 illustrates a projection of the content 110 in an example second configuration based on a change to the light reflective material 102. In the second configuration, the light reflective material 102 may define a second projectable area 106B. For example, in the second configuration, the light reflective material 102 may have a second shape defining the second projectable area 106B different than the first projectable area 106A. As shown in FIG. 5, the subareas of FIG. 4 may unite into a single projectable area.

FIG. 6 illustrates a projection of the content 110 in an example third configuration based on a further change to the light reflective material 102. In the third configuration, the light reflective material 102 may define a third projectable area 106C. For example, in the third configuration, the light reflective material 102 may have a third shape defining the third projectable area 106C different than the first projectable area 106A and the second projectable area 106B.

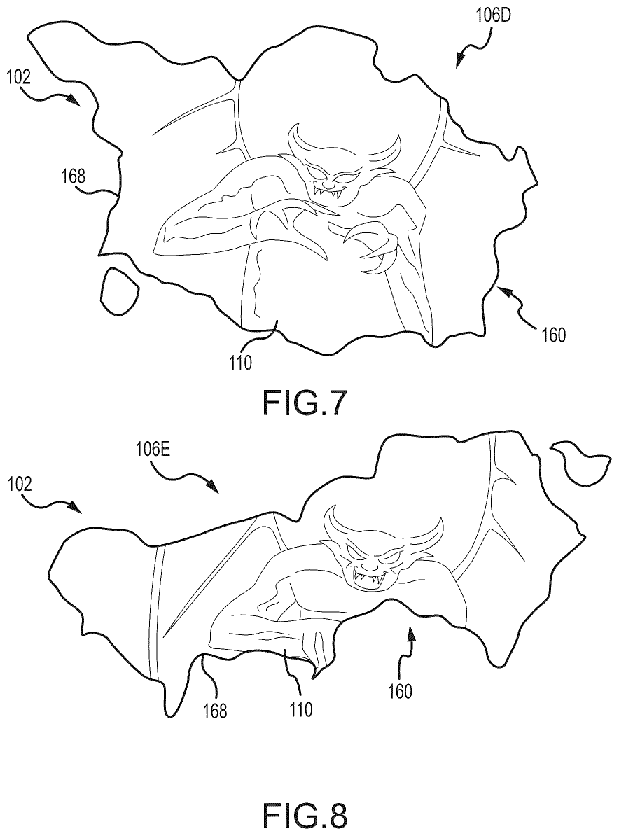

FIG. 7 illustrates a projection of the content 110 in an example fourth configuration based on a further change to the light reflective material 102. In the fourth configuration, the light reflective material 102 may define a fourth projectable area 106D. For example, in the fourth configuration, the light reflective material 102 may have a fourth shape defining the fourth projectable area 106D different than the first projectable area 106A, the second projectable area 106B, and the third projectable area 106C.

FIG. 8 illustrates a projection of the content 110 in an example fifth configuration based on a further change to the light reflective material 102. In the fifth configuration, the light reflective material 102 may define a fifth projectable area 106E. For example, in the fifth configuration, the light reflective material 102 may have a fifth shape defining the fifth projectable area 106E different than the first projectable area 106A, the second projectable area 106B, the third projectable area 106C, and the fourth projectable area 106D.

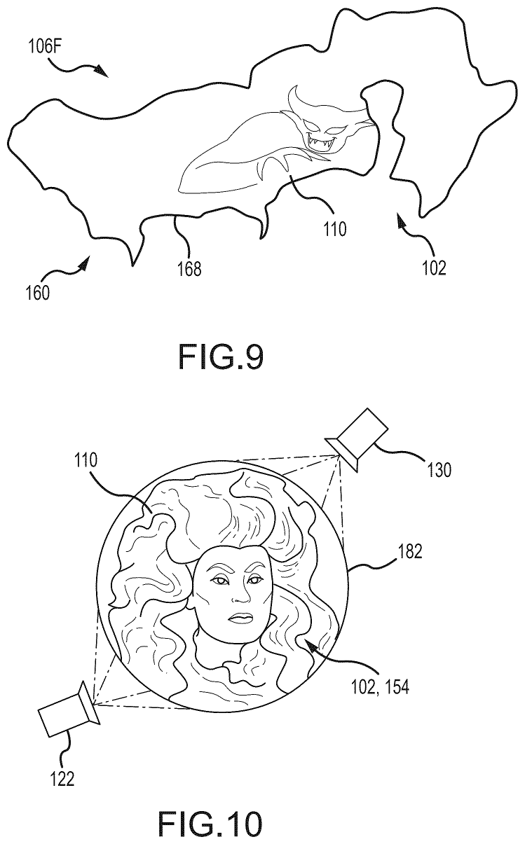

FIG. 9 illustrates a projection of the content 110 in an example sixth configuration based on a further change to the light reflective material 102. In the sixth configuration, the light reflective material 102 may define a sixth projectable area 106F. For example, in the sixth configuration, the light reflective material 102 may have a sixth shape defining the sixth projectable area 106F different than the first projectable area 106A, the second projectable area 106B, the third projectable area 106C, the fourth projectable area 106D, and the fifth projectable area 106E.

Referring to FIGS. 4-9, the controller 116 may be configured to determine a periphery of the second, third, fourth, fifth, and sixth projectable areas 106B, 106C, 106D, 106E, 106F and adjust the content 110 to include the border 168 along their respective peripheries. The content 110 may correspond to the respective projectable areas. For example, the controller 116 may fit the content 110 to each projectable area, such as to fit the content 110 within the border 168. In one example, the controller 116 may be configured to adjust the content 110 based on a change to the border 168. For example, as the border 168 shrinks or expands, the controller 116 may adjust the content 110, such as to modify the content 110 to interact with the border 168, to adjust orientations or actions of characters within the content 110 to fit or match the border change, to reform characters corresponding to the border change, or the like. As a result, the projected characters may shape-shift, such as dynamically to the unique shape of the projectable area 106. In examples without a border 168, the controller 116 may adjust the content 110 in a similar way to fit or match the content 110 to the changing size or shape of the projectable area 106. In this manner, animations provided in the content 110 may be opportunistically and adaptively determined by the available shape and size of the projectable area 106. In this manner, the content 110 may be dynamic and correspond to the dynamic light reflective material 102.

Referring to FIGS. 2-9, the light reflective material 102 may be dynamic. For example, one or more characteristics of the light reflective material 102 may change based on environmental conditions, input, generation conditions, etc. In such examples, the controller 116 may be configured to modify the content 110 based on a change to a detected characteristic of the dynamic light reflective material 102. For example, the light reflective material 102 may define a diffuse projection cloud of particles (e.g., suspended or floating in air, suspended or floating on or in water or other transparent liquid). In such example, the system 100 may include a diffuser 176 (e.g., fog machine 162, a smoke machine, etc.) configured to diffuse the particles in the air or liquid.

The controller 116 may be configured to modify a position or a shape of the content 110 as the diffuse projection cloud dissipates. For example, a position or shape of one or more characters projected in the content 110 may be adjusted to move the characters with the dissipating diffuse projection cloud. In such examples, the camera 112 or another sensor may be configured to track the position of the light reflective material 102. In another example, the controller 116 may be configured to determine a usable projectable area 106 (e.g., the first projectable area 106A, second projectable area 106B, etc.) defined by the light reflective material 102 as the diffuse projection cloud dissipates. For example, the controller 116 may be configured to modify the content 110 to fit the content 110 to an updated size and shape of the usable projectable area. In another example, as the controller 116 may be configured to adjust the brightness of the projector 130 to compensate for thinning and less reflective areas so as to provide uniform images even when the projectable area 106 is thinning, but still above a minimum thickness and reflectivity to support a viable image.

FIG. 10 illustrates another example projection of content 110 onto light reflective material 102. The light reflective material 102 may be defined by or within an otherwise clear balloon 182. For example, the balloon 182 may be filled with smoke 154 or another suspended nontransparent material. The balloon 182 may be tracked and projected upon. In one example, the balloon 182 may be held or positioned using a cable system. For example, a three-cable winch or cable system may be used for full position control of the balloon 182. In another example, the balloon 182 may be suspended on a collimated stream of air.

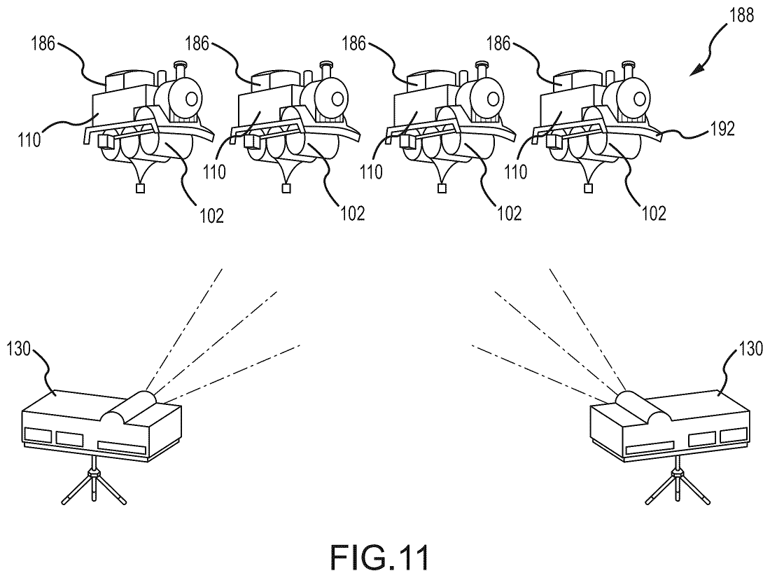

FIG. 11 illustrates another example projection of content 110 onto light reflective material 102. The light reflective material 102 may be defined by a floating or suspended structure or screen (hereinafter “float” 186 without intent to limit). In one example, the float 186 may be suspended from a ground vehicle. In such examples, the ground vehicle may move to move the float 186 within the air. The float 186 may be tracked and projected upon. For example, one or more projectors 130 may project the content 110 onto the float 186 as the float 186 moves. In another example, multiple floats 186 may be arranged adjacent one another, such as in a line (e.g., an “air train” 188). In such examples, each float 186 within the train 188 may include the same or different imagery.

Referring to FIGS. 2-11, a projection of the content 110 may move from one surface to another surface. For example, the projection may start on a ground-based object 190 (see FIG. 2), such as buildings, towers, attraction frameworks, vehicles, etc. Projected images may transfer (e.g., “leap”) from the ground-based object 190 to an air-based object 192 (see FIG. 11), such as to a diffuse projection cloud (e.g., fireworks residue 146, smoke 154, fog 160, etc.), a floating tethered projection screen (e.g., float 186), etc. In another example, projected images may transfer from the air-based object 192 to the ground-based object 190, or back and forth.

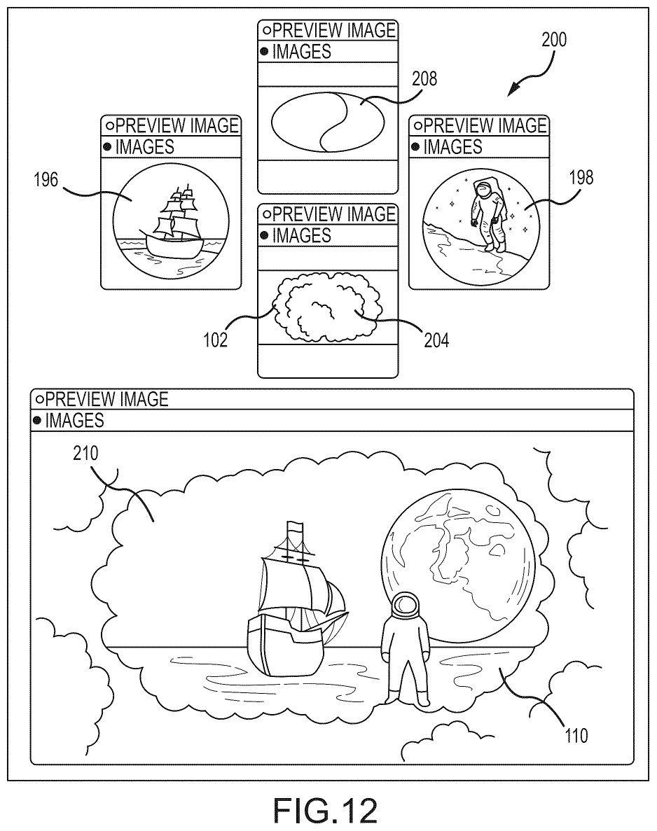

FIG. 12 illustrates an example generation of the content 110. In one example, the controller 116 may generate imagery that combines multiple images into a single image based on the characteristics of the light reflective material 102. For example, the controller 116 may receive a first image 196 and a second image 198 as input to an image generator 200. In addition, the camera 112 may provide a captured image 204 of the light reflective material 102. In such examples, the image generator 200 may determine a blended image framework 208 that tracks the size and shape of the light reflective material 102 and outlines the extent or share of the final image allotted to each of the first image 196 and the second image 198. Based on the blended image framework 208, the controller 116 may generate a blended image 210 that combines elements of the first image 196 and the second image 198.

In some examples, the controller 116 may be configured to utilize generative artificial intelligence (AI) to create or modify the content 110. For example, the controller 116 may use machine learning to create the content 110 or modify the content 110 to fit the usable projectable area 106. In one example, the controller 116 uses generative models to generate text, images, videos, or other forms of data based on training data. The generative AI models may use the training data to produce or modify the content 110 based on input. The input may include natural language prompts and/or the characteristics of the light reflective material 102 detected by the camera 112 (e.g., the detected size and shape of the projectable area 106).

One example implementation of the system 100 may include a smoke-filled balloon (e.g., balloon 182). The smoke-filled balloon 182 may provide an initiating source of diffuse projection material (e.g., light reflective material 102). For example, a figure of a humanoid character enclosed in a spherical prison may be projected onto the light reflective material 102 within the balloon 182. The character may be seen to be banging its fists against the sides of the balloon 182, trying to get out. The balloon 182 may burst to release the light reflective material 102. For example, the system 100 may remotely cause the balloon 182 to burst, and the entrained smoke 154 may move out into a diffuse cloud of arbitrary shape. The system 100 (e.g., controller 116) may determine the available shape of the diffuse cloud of smoke 154 and reform the character, for example, so that the character extrudes into the available space. This action may dismay the character, with the character pulling itself into a larger remaining area. Comically, the character may find that one of its appendages is still positioned in another part of the cloud. Thus, the projected animation may be completely determined by the available shape and size of a particular cloud of light reflective material 102.

Another example implementation of the system 100 may include a diffuse cloud of light reflective material 102 (e.g., a cloud of smoke 154) that randomly breaks into multiple parts. For example, a character may be initially projected upon the originating cloud. When the cloud splits, the character may comically split itself into corresponding parts. For example, the character may split itself into twins, with one larger than the other corresponding to different sizes of the split cloud of light reflective material 102. In another example, a part of a character, for instance a dog, may have most of its body in a larger split of the smoke cloud and its tail, still wagging, in another part of the split smoke cloud.

Another example implementation of the system 100 may include an inverse-type opportunistic projection. For example, multiple images may be projected on separate areas of light reflective material 102 (e.g., separate smoke clouds). The separate clouds may drift into one another, uniting to create a larger projectable area 106. The separate images may unite with the combining of the clouds. The theming for the combination may be coherent. For example, a cart and a horse may unite to drive off in the combined cloud.

Another example implementation of the system 100 may include an interaction on a smaller scale of projection, such as in a theatrical stage show, where a guest or actor may interact with the content 110. The system 100 may detect an action performed by the guest or actor, for example, a waving of a wand or a hand gesture. In another example, the system 100 may detect a position of the guest relative to the light reflective material 102. Based on the detected action or position, the controller 116 may modify or change the content 110. For example, the content 110 may interact with the guest or actor. In another example, the content 110 may be adjusted to match the point-of-view (POV) of the guest, for example, a projected head turning to correspond with a detected location of the guest or viewer.

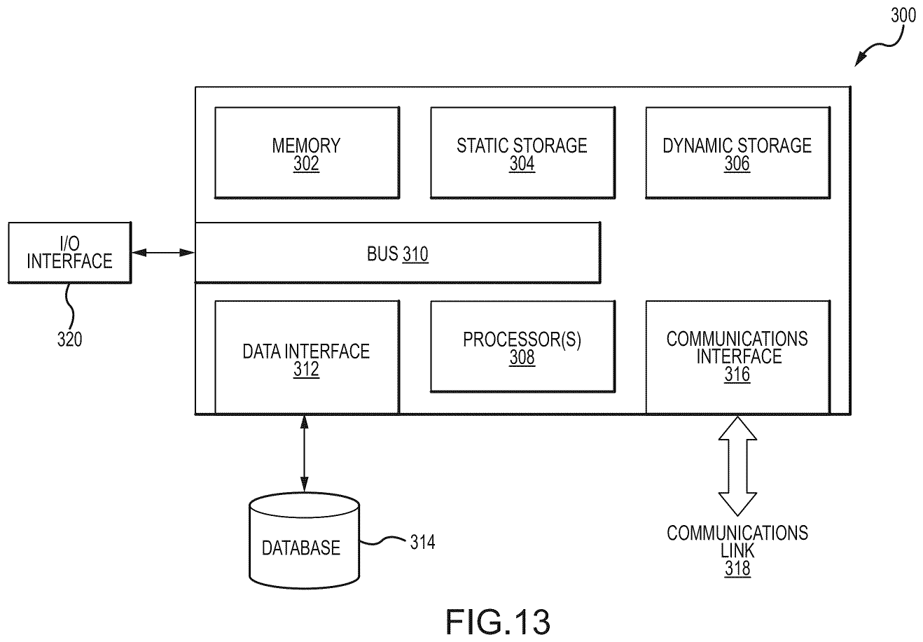

FIG. 13 illustrates an example computing system 300 for implementing various examples of the present disclosure. For example, in various embodiments, components of the system or other systems described herein may be implemented by one or several computing systems 300. This disclosure contemplates any suitable number of computing systems 300. For example, the computing system 300 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 300 may include one or more computing systems; be unitary or distributed; span multiple locations; span multiple machines; span multiple data centers; or reside in a cloud, which may include one or more cloud components in one or more networks (e.g., network 138).

Computing system 300 includes a bus 310 (e.g., an address bus and a data bus) or other communication mechanism for communicating information, which interconnects subsystems and devices, such as processor 308, memory 302 (e.g., RAM), static storage 304 (e.g., ROM), dynamic storage 306 (e.g., magnetic or optical), communications interface 316 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 320 (e.g., keyboard, keypad, mouse, microphone, display). In examples, the computing system 300 may include one or more of any such components.

In examples, processor 308 includes hardware for executing instructions, such as those making up a computer program. For example, processor 308 may execute instructions for various components of the system 100, the image generator 200, or other systems described herein (e.g., the controller 116). The processor 308 circuity includes circuitry for performing various processing functions, such as executing specific software to perform specific calculations or tasks. In examples, I/O interface 320 includes hardware, software, or both, providing one or more interfaces for communication between computing system 300 and one or more I/O devices. Computing system 300 may include one or more of these I/O devices, where appropriate. One or more of these I/O devices may enable communication between a person and computing system 300.

In examples, the communications interface 316 includes hardware, software, or both providing one or more interfaces for communication (such as, for example, packet-based communication) between computing system 300 and one or more other computer systems or one or more networks (e.g., network 138). One or more memory buses (which may each include an address bus and a data bus) may couple processor 308 to memory 302. Bus 310 may include one or more memory buses, as described below. In examples, one or more memory management units (MMUs) reside between processor 308 and memory 302 and facilitate accesses to memory 302 requested by processor 308. In examples, bus 310 includes hardware, software, or both coupling components of computing system 300 to each other.

The computing system 300 performs specific operations by processor 308 executing one or more sequences of one or more instructions contained in memory 302. For example, instructions for the system 100, image generator 200, or other systems described herein (e.g., to perform the operations described above) may be contained in memory 302 and may be executed by the processor 308. For example, the processor 308 may be configured to modify the content 110 based on a detected change to the light reflective material 102, as described herein. In examples, the processor 308 may be configured to modify a configuration of the content 110 based on sensory input (e.g., based on a detected size and shape of the projectable area 106). In such examples, the processor 308 may be in communication with the camera 112. Based on the detected characteristics of the light reflective material 102, the processor 308 may create or adjust the content 110, such as adjusting the content 110 to fit the projectable area 106 or to change the strength of the projected visible light to compensate for the specific density of the light reflective material 102, and therefore reflectivity, of the invisible and visible light.

Such instructions may be read into memory 302 from another computer readable/usable medium, such as static storage 304 or dynamic storage 306. In alternative embodiments, hard-wired circuitry may be used in place of or in combination with software instructions. Thus, the disclosed examples are not limited to any specific combination of hardware circuitry and/or software. In various embodiments, the term “logic” means any combination of software or hardware that is used to implement all or part of the examples disclosed herein.

The term “computer readable medium” or “computer usable medium” as used herein refers to any medium that participates in providing instructions to processor 308 for execution. Such a medium may take many forms, including but not limited to, nonvolatile media and volatile media. Non-volatile media includes, for example, optical or magnetic disks, such as static storage 304 or dynamic storage 306. Volatile media includes dynamic memory, such as memory 302.

Computing system 300 may transmit and receive messages, data, and instructions, including program, e.g., application code, through communications link 318 and communications interface 316. Received program code may be executed by processor 308 as it is received, and/or stored in static storage 304 or dynamic storage 306, or other storage for later execution. A database 314 may be used to store data accessible by the computing system 300 by way of data interface 312. In various examples, communications link 318 may communicate with the system 100 or other systems described herein.

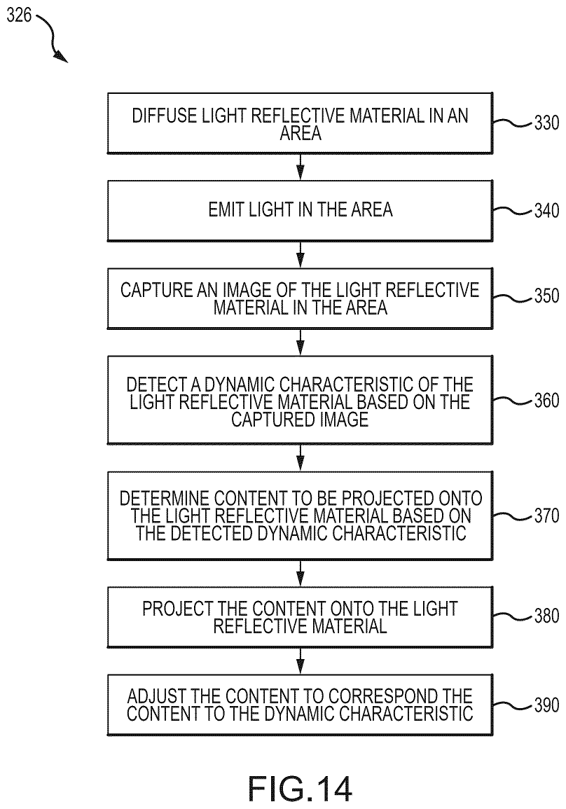

FIG. 14 illustrates an example method 326 for projecting content (e.g., content 110) onto a surface or material (e.g., light reflective material 102). The method 326 may be implemented using the various systems described herein, such as the system 100 or the computing system 300 (e.g., the processor 308). Any of the illustrated steps may be optional or omitted, or combined with another step.

At step 330, the method 326 includes diffusing light reflective material 102 in an area (e.g., area 118), such as in a manner as described herein. For example, a fog machine 162, smoke machine, or another diffuser 176 may diffuse particles suspended in air, such as to create a diffuse projection cloud. In another example, the light reflective material 102 may be diffused through explosive residue 146 from air-launched fireworks 144.

At step 340, the method 326 includes emitting light 124 in the area 118, such as in a manner as described herein. For example, the light source 122 may illuminate the area 118 with IR light.

At step 350, the method 326 includes capturing an image of light reflective material (e.g., light reflective material 102) in the area 118, such as in a manner as described herein. For example, the camera 112 may capture an IR image of the light reflective material 102. The light reflective material 102 may be a screen, a fabric, smoke 154, fog 160, firework residue 146, or other elements or material.

At step 360, the method 326 includes detecting a dynamic characteristic of the light reflective material 102 based on the captured image, such as in a manner as described herein. For example, one or more characteristics of the light reflective material 102 may be detected based on a reflection of the emitted light off the light reflective material 102. In examples, step 360 includes detecting an updated characteristic of a changing light reflective material 102 (e.g., as the light reflective material 102 dissipates or moves.

At step 370, the method 326 includes determining content 110 to be projected onto the light reflective material 102 based on the detected dynamic characteristic, such as in a manner as described herein. In examples, step 370 includes determining a periphery of the projectable area 106 defined by the light reflective material 102. A border (e.g., border 168) along the periphery may be included in the content 110. In examples, step 370 includes using generative AI to create the content 110.

At step 380, the method 326 includes projecting the content 110 onto the light reflective material 102, such as in a manner as described herein. For example, the projector 130 may project the content 110 onto the light reflective material 102.

At step 390, the method 326 includes adjusting the content 110 to correspond (e.g., conform) the content 110 to the dynamic characteristic, such as in a manner as described herein. In one example, the content 110 may be adjusted based on updated characteristics of the light reflective material 102, such that the content 110 corresponds to the changing light reflective material 102. In another example, the content 110 may be modified based on a change to the detected characteristic of the dynamic light reflective material 102. In examples, step 390 includes adjusting the content 110 to fit the content 110 within an updated projectable area 106 defined by an updated size and shape of a diffuse projection cloud defined by the light reflective material 102. In examples, step 390 includes adjusting the content 110 based on a change to the border 168 or periphery of the projectable area 106. In examples, step 390 includes modifying a position or a shape of the content 110 as the light reflective material 102 (e.g., diffuse projection cloud) dissipates. In examples, step 390 includes adjusting the content 110 using generative AI. In examples, step 390 includes adjusting the projector brightness to provide an ultimately uniform or generally uniform projected image.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system comprising:
a camera configured to capture an image of a light reflective material in an area; and
a controller configured to:
detect, based on the captured image, a dynamic characteristic of the light reflective material; and
determine, based on the detected dynamic characteristic, content to be projected onto the light reflective material.

2. The system of claim 1, wherein the controller is further configured to adjust the content to conform the content to the dynamic characteristic.

3. The system of claim 1, wherein the dynamic characteristic comprises a continuously varying characteristic of the light reflective material.

4. The system of claim 1, wherein the dynamic characteristic comprises a changing size and shape of a projectable area defined by the light reflective material.

5. The system of claim 1, wherein the light reflective material is defined by particles suspended or floating in air.

6. The system of claim 5, wherein the particles comprise at least one of firework residue, fog, smoke, mist, or clouds.

7. The system of claim 1, wherein the light reflective material is defined by particles suspended or floating on or in water or other transparent liquid.

8. The system of claim 1, wherein the light reflective material comprises an undulating flexible material.

9. The system of claim 1, further comprising a light source configured to emit light in the area, wherein the controller is configured to detect the dynamic characteristic based on a reflection of the light off the light reflective material.

10. The system of claim 9, wherein the light is nonvisible light.

11. The system of claim 9, wherein the light source is configured to emit a short pulse of visible projection light used to determine the dynamic characteristic of the light reflective material.

12. The system of claim 1, wherein the controller is configured to detect a variation in uniformity of the light reflective material, and to determine, based on the detected variation in uniformity, a correction matte required to provide a uniform image brightness across the light reflective material.

13. The system of claim 1, further comprising a distance sensor configured to determine a distance from the camera or a projector to the light reflective material.

14. The system of claim 13, wherein the light reflective material defines multiple separate projectable areas at varied distances from the camera or the projector, and wherein the multiple separate projectable areas are used to provide a construction of visible multiplane or sloped three-dimensional images.

15. The system of claim 1, further comprising a projector configured to project the content onto the light reflective material.

16. The system of claim 1, wherein the controller is configured to:
detect, based on the captured image, an updated characteristic of the light reflective material; and
adjust, based on the updated characteristic, the content such that the content corresponds to the light reflective material.

17. The system of claim 16, wherein the updated characteristic comprises an updated projectable area defined by the light reflective material, and wherein the controller is configured to adjust the content to fit the content within the updated projectable area.

18. The system of claim 16, wherein the updated characteristic comprises an updated density of the light reflective material.

19. The system of claim 1,
wherein the light reflective material defines a projectable area; and
wherein the controller is configured to:
determine a periphery of the projectable area; and
adjust the content to include a border along the periphery.

20. The system of claim 18, wherein the controller is configured to further adjust the content based on a change to the border along the periphery.

21. A system comprising:
a light source configured to emit nonvisible light in an area;
a projector configured to project content onto a dynamic light reflective material in the area;
a sensor configured to detect a characteristic of the dynamic light reflective material based on a reflection of the nonvisible light off the dynamic light reflective material; and
a controller configured to modify the content based on a change to the detected characteristic of the dynamic light reflective material.

22. The system of claim 21, wherein the dynamic light reflective material defines a diffuse projection cloud of particles suspended in air.

23. The system of claim 22, further comprising a diffuser configured to diffuse the particles in the air.

24. The system of claim 22, wherein the controller is configured to modify a position or a shape of the content as the diffuse projection cloud dissipates.

25. The system of claim 22, wherein the controller is further configured to:
determine a usable projectable area defined by the dynamic light reflective material as the diffuse projection cloud dissipates; and
define a border for projection along a periphery of the usable projectable area.

26. The system of claim 25, wherein the controller is configured to modify the content to interact with the border.

27. The system of claim 21, wherein the change comprises an updated size and shape of a projectable area defined by the dynamic light reflective material, and wherein the controller is configured to modify the content to fit the content to the updated size and shape.

28. The system of claim 21, wherein the sensor is configured to track a position of the dynamic light reflective material.

29. The system of claim 21, wherein the dynamic light reflective material is defined by a floating or suspended structure.

30. The system of claim 21, wherein the controller is configured to utilize generative artificial intelligence (AI) to create or modify the content.

31. A method comprising:
detecting, by a processor and based on an image of a light reflective material, a dynamic characteristic of the light reflective material; and
determining, by the processor and based on the detected dynamic characteristic, content to be projected onto the light reflective material.

32. The method of claim 31, further comprising:
detecting, by the processor and based on a subsequent image of the light reflective material, a change to the detected dynamic characteristic; and
adjusting, by the processor, the content based on the detected change.
